(19) United States
(12) Patent Application Publication
(10) Pub. No.: US 2005/0204937 A1
(43) Pub. Date: Sep. 22, 2005

(54) Apparatus for peeling and scrubbing produce

(76) Inventor: Thomas D. Baird, North Fork, CA (US)

Correspondence Address: Richard A. Ryan;RYAN & ENGNATH, Suite 104, 8469 N. Millbrook, Fresno, CA, 93720, US

(21) Appl. No.: 10/804,701

(22) Filed: Mar. 18, 2004

(51) Int. Cl. B08B 3/00

(52) U.S. Cl. 99/623

(57) ABSTRACT

An apparatus for peeling and scrubbing produce, such as fruits and vegetables, has a housing enclosing a chamber configured to receive the produce. The apparatus is sized and configured to be used on a counter or table top and easily moved. Abrasive rollers are rotatably and removably disposed in the chamber and configured to peel or scrub the skin or outer layer of the produce. In one embodiment, an electric motor drives a belt drive system having a plurality of pulleys. A fluid spray system delivers fluid to the chamber to wash the produce. A fluid container in the fluid line can store and deliver cleaning fluids. A discharge opening allows the produce refuse to discharge from the apparatus. In one configuration, the rollers have a plurality of outwardly extending bristles. A controller mechanism controls the operation of the motor. A removable basket can be used for small sized produce.

### CROSS-REFERENCE TO RELATED APPLICATIONS

Not Applicable.

### BACKGROUND OF THE INVENTION

A. Field of the Invention

The field of the present invention relates generally to apparatuses for peeling or scrubbing produce such as fruits and vegetables. More specifically, the present invention relates to such apparatuses that utilize a plurality of motor-driven abrasive rollers to peel or scrub the produce and a spray mechanism adapted to wash the produce. Even more specifically, the present invention relates to such apparatuses that have easily interchangeable rollers to select between peeling or scrubbing operations and which are particularly configured for home and/or portable use.

B. Background Although fresh produce such as fruits and vegetables are known to be generally enjoyable and healthy for people to eat, it is also generally well known that fresh fruits and vegetables require some preparation of the fruit or vegetable prior to consumption. Preparation of the produce is typically necessary whether the fresh fruit or vegetable is to be eaten raw, cooked or incorporated into another food item, such as a pie, salad or the like. For instance, it is generally well understood, and recommended by health officials, that fresh fruits and vegetables should not be eaten without removing the chemicals, chemical residue, pest, dirt, human contamination (including viruses and bacteria) and other materials that accumulate on produce during its growing, harvesting, transport and handling. Although a certain level of cleaning may be obtained by rinsing or washing the fruit or vegetable with, at a minimum, water or a water-based cleaning fluid, it is generally necessary to do much more to effectively clean the produce to remove the potentially harmful materials. In fact, studies indicate that fruits and vegetables should be soaked for at least fifteen minutes in a water and soap solution followed by scrubbing to remove chemicals, chemical residue and other potentially harmful contaminants. In addition to scrubbing the fruit or vegetable, many people prefer to utilize a cleaning solution, which may be mixed with water, to more thoroughly remove the pesticide, fungicide or other chemicals commonly found on most fruits and vegetables. Naturally, any such cleaning solutions should not be harmful to the produce. To improve the cleaning effectiveness of the water and/or cleaning solution, the fluid is often supplied under pressure by utilizing a spray nozzle or other mechanism to deliver the water to the fruits or vegetables.

In addition to scrubbing and cleaning the fresh fruit or vegetables prior to eating, many people prefer to peel the skin or other outer portion from the fruit or vegetable prior to consumption or incorporation into another food dish. Although the outer portion of the fruit or vegetable may be edible, many people prefer to eat the fruit or vegetable without the skin or outer layer. Certain fruits, such as apples and pears, are more desirable to some people without their tougher outer skin. Potatoes, carrots and many other vegetables also have an outer skin layer that most people generally prefer to remove prior to consumption. Even for those fruits or vegetables that have edible or commonly eaten skins, it is often desirable or necessary to remove the skin (i.e., child eating preferences, certain recipes and etc.). The typical device used by the individual consumer for removing skin from a fruit or vegetable is a knife or a specially configured hand-held peeling tool. Most restaurants and other eating establishments also utilize hand-held devices, such as knives and peeling tools. Naturally, the goal of anyone using a knife or other device configured to remove the skin or outer layer from a fruit or vegetable is to remove the skin or outer layer without substantially damaging and/or wasting the inner edible portion of the produce. Typically, the skin or outer layer of the produce is disposed of or used as compost.

For commercial produce operations, where large volumes of fruits and vegetables are peeled or scrubbed on a routine basis, a number of high capacity machines are presently available. In general, these machines utilize rotating abrasive rollers and spray mechanisms to peel or scrub and then rinse the fruit and/or vegetable produce with either a drum /cage or auger mechanism to move the produce through the machine. These machines utilize a drive system, which may be electric, hydraulic or pneumatic, for rotating the rollers and operating the movement mechanism. Although some machines utilize direct drive mechanisms to rotate the rollers, most machines utilize some type of belt drive mechanism to interconnect the drive system and the rollers. Produce that enters the machine is contacted by the abrasive rollers in a manner that at least slightly abrades the produce to clean dirt and other materials and/or peel the skin or outer layer off the produce. The abrasive rollers typically used for scrubbing comprise a plurality of brush bristles which extend radially outward from the center section of the roller to engage the produce so as to scrub the produce clean. Other rollers are configured with a rough, sandpaper-like outer surface to abrade (i.e., peel) the produce. During the abrading process, water or other cleaning solvents are typically sprayed or washed over the produce to wash away the peeled skin/outer surface or any dirt or other materials on the produce. As known to those skilled in the art, the rollers used for scrubbing produce are configured differently than those used to peel produce.

Various commercial-sized produce peeling or scrubbing machines are described in the prior art. For instance, U.S. Pat. No. 5,780,088 to Zittel, et al., sets forth a peeling and washing machine that utilizes a plurality of independently driven abrasive rollers that are mounted to spaced apart end plates that configure the rollers in a generally semicircular produce receiving chamber. The motors are mounted to motor mounting plates at an end plate in a manner that allows the shaft to extend through the end plate and interconnect with one of the rollers. U.S. Pat. No. 5,351,610 to Jonsson describes a peeling machine having a series of rotating abrasive rollers formed in a concave surface that are driven by an electric motor with a belt drive system. A Carborundum grit coating covers the rollers to peel away the outer layer of the produce. U.S. Pat. No. 5,307,738 to Amstad discloses a food processing machine having a pair of inverted frusto-conical rotatable members which are concentrically spaced from one another to provide a cleaning space between the members. A plurality of product abrading members are arranged inside the cleaning space to abrade the produce as circumferential force from rotation of the rotatable members causes the produce to move upward in the cleaning space. U.S. Pat. No. 4,132,162 to Magnuson describes a produce peeling apparatus having a cylindrical rotary drum mechanism with a plurality of abrasive rollers at the drum wall and a screw auger to move the produce through the drum mechanism. The auger axle has a plurality of spray nozzles to spray water or other cleaning fluid on the produce as it moves through the drum mechanism. U.S. Pat. No. 1,995,693 to Urschel describes a vegetable peeler that utilizes various gear mechanisms to rotate abrasive rollers located at the bottom portion of a hopper with a water spray mechanism at the top of the hopper to spray water or other fluids onto the produce while it is being peeled by the rollers.

While the various patents identified above describe machines that are or may be suitable for peeling or scrubbing and then cleaning fruits and vegetables on a large scale basis, they are not configured or particularly useful for peeling or scrubbing fresh produce in the typical home or restaurant. For instance, the above machines, as well as others known to exist, are not configured to allow easy interchanging of the different type of abrasive rollers that are used for peeling or for scrubbing, thereby limiting (at least from a practical standpoint) the machine to peeling or scrubbing operations. The presently available machines are generally too complicated and require too much of an infrastructure, including space, water supply and power requirements, to be useful for the typical home or restaurant setting. The presently available apparatuses are also not very well configured to wash smaller sized fruits and vegetables, such as berries and cherry tomatoes. In addition, many of the presently existing machines are too expensive and too difficult to operate for the typical home or restaurant food preparer. What is needed, therefore, is an apparatus for peeling and scrubbing produce that can be configured to effectively scrub the produce to remove contaminants or peel the produce by removing the skin or outer layer of the produce without substantially damaging the inner edible portion thereof. The preferred apparatus should be configured to be able to selectively scrub or peel produce with one or more abrasive rollers and clean the produce with water or other cleaning fluids. The apparatus should be suitable for washing small sized fruits and vegetables. The apparatus should be relatively inexpensive to manufacture, simple to utilize and generally suitable for use in the typical home or restaurant environment.

### SUMMARY OF THE INVENTION

The apparatus for peeling and scrubbing produce of the present invention solves the problems and provides the benefits identified above. That is to say, the present invention discloses an apparatus for peeling and scrubbing produce that is particularly configured to be used in the typical home or restaurant environment and effectively scrub the produce clean or peel the produce by removing the skin or outer layer of the produce and then wash the produce with water or other desired cleaning fluids. The apparatus of the present invention includes removable rollers to allow the user to select a roller of the appropriate size and abrasiveness for the fruits or vegetables being peeled or scrubbed. The apparatus for peeling and scrubbing produce of the present invention is also configured to wash small sized fruits and vegetables. The apparatus of the present invention can be made out of a wide variety of materials and in a wide variety of shapes and sizes. In the preferred embodiment, the peeling and cleaning apparatus includes a separate fluid container to allow the user to add cleaning fluids to the spray wash.

In one aspect of the present invention, the apparatus for peeling and scrubbing produce has a housing, spray system, one or more removable rollers, roller rotating mechanism and a motor. The housing has one or more side walls, a bottom wall and a lid that forms a substantially closeable chamber in the housing. The spray system is configured to spray a fluid, such as water and/or a cleaning fluid, in the chamber to wash the produce and discharge the produce refuse. The spray system has one or more spray nozzles connected to a fluid line, which is adapted for connection to a source of fluid, such as a water faucet. At least a portion of the spray nozzles are operatively disposed inside the chamber. Each of the rollers have abrasive elements, such as a plurality of outwardly extending bristles or an abrading outer surface, for scrubbing or peeling the produce that are rotatably disposed inside the chamber. In the preferred embodiment, the rollers are removably disposed inside the chamber to allow the user to select the appropriate rollers depending on the desired action, the type and/or size of produce and to allow easy replacement of rollers as necessary. The rotating mechanism is operatively connected to each of the rollers and configured to rotate the rollers. The motor, which can be electric, hydraulic, pneumatic or other type of motor, is configured to drive the rotating mechanism to rotate the rollers. A controller can be used to control the operation of the motor and rollers. The components of the apparatus are sized and configured so that the apparatus can be used on a counter or table top in a home or restaurant. A fluid container can be removably connected to the fluid line for storing a cleaning solution and delivering the cleaning solution to the chamber when fluid flows through the fluid line. The spray nozzles can be attached to or incorporated in the lid and a portion of the fluid line can be disposed inside the lid. Brackets configured to engage one end of the rollers can be used to secure (i.e., snap-in) the rollers into the chamber. The chamber can be adapted to receive a basket configured for holding small sized produce to scrub the fruit held therein. A removable upper component, having one or more upper rollers rotatably attached to a roller frame, can be utilized to confine the produce between the rollers and the upper rollers. If desired, the apparatus can include a reservoir compartment configured to store the source of fluid and a pump configured to pump the fluid through the fluid line to the spray nozzles.

Accordingly, the primary objective of the present invention is to provide an improved apparatus for peeling and scrubbing produce that provides the advantages discussed above and that overcomes the disadvantages and limitations associated with presently available produce peeling or scrubbing apparatuses.

It is also an important objective of the present invention to provide an apparatus for peeling and scrubbing produce that is particularly configured for use on a counter or table top in home and office environments and adaptable to a variety of different types and sizes of fruits and vegetables.

It is also an important objective of the present invention to provide an apparatus for peeling and scrubbing produce that comprises one or more replaceable abrasive rollers to allow selection of the appropriate rollers based on the desired peeling or scrubbing action and the size and type of fruit or vegetable to be acted upon.

It is also an important objective of the present invention to provide an apparatus for peeling and scrubbing produce that includes a spray system that includes a selectively refillable container for incorporating cleaning fluid into the fluid to be sprayed on the fruits and vegetables.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a top plan view of the apparatus for peeling and scrubbing produce of the present invention with the lid and drive belt removed;

FIG. 2 is a side view of the apparatus for peeling and scrubbing produce of the present invention shown in FIG. 1 with the side wall removed;

FIG. 3 is a back partial cross-sectional view of the apparatus for washing produce of FIG. 1 with the back wall removed and the spray mechanism operating to spray fluid inside the chamber; FIG. 4 is a side view of a roller having a plurality of bristles;

FIG. 5 is a side view of an alternative configuration of the apparatus for washing produce of the present invention showing use of a basked positioned inside the chamber for scrubbing small fruits and vegetables and a discharge hose for discharging fluid and refuse from the apparatus; and

FIG. 6 is a side view of an alternative configuration of the apparatus for washing produce of the present invention showing use of an upper component to enclose the fruits and vegetables and a reservoir to store fluid for washing the produce.

### DETAILED DESCRIPTION OF THE PREFERRED EMBODIMENTS

With reference to the figures where like elements have been given like numerical designations to facilitate the reader's understanding of the present invention, and particularly with reference to the embodiment of the apparatus for peeling and scrubbing produce of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

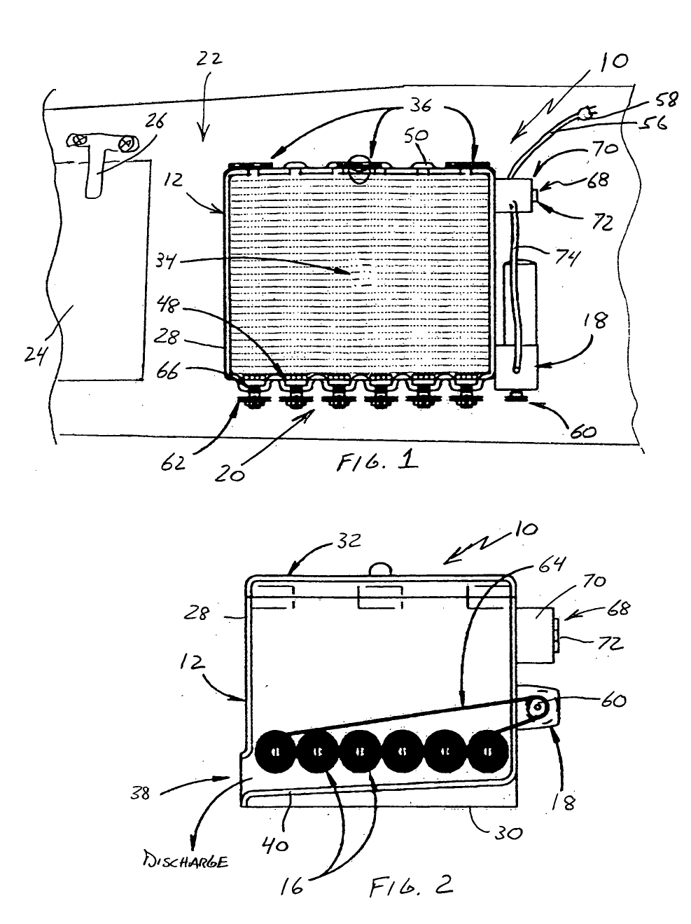

A preferred embodiment of the apparatus for peeling and scrubbing produce, including fruits and vegetables, of the present invention, identified generally as 10 in the figures, primarily comprises housing 12, fluid spray system 14, one or more abrasive rollers 16, motor 18 and rotating mechanism 20 for rotating rollers 16 inside housing 12, as shown in FIGS. 1 through 3. The produce peeling and scrubbing apparatus 10 of the present invention is particularly configured for use in homes and restaurants by being adaptable for placement on the top of a counter, table or like surface, shown generally as 22 in FIG. 1. In the illustration of FIG. 1, apparatus 10 is located on a counter top 22 having a sink 24 and source of water 26 for use with the apparatus 10 of the present invention (as set forth below). As such, unlike known prior art devices, apparatus 10 of the present invention should be sized and configured to not take up an excessive amount of space in the kitchen, whether in use or stored in a cabinet, closet or other location, and fit on the surface of counter or table 22. The materials for apparatus 10 should be selected so as to not result in excessive weight for apparatus 10 so the homemaker or restaurant worker will not have any difficulty lifting or moving apparatus 10 between its storage location and place of use. In addition, it is generally preferred that apparatus 10 of the present invention be designed to be aesthetically pleasing so that apparatus 10 will not look out of place in most home or restaurant kitchens.

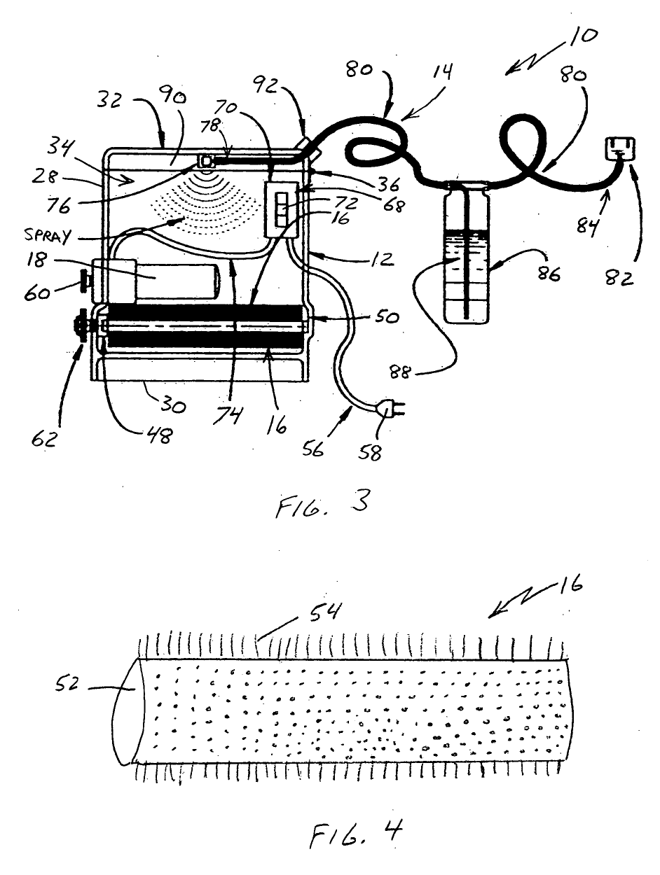

In the preferred embodiment, best shown in FIGS. 2 and 3, housing 12 has one or more side walls 28, a bottom wall 30 and a lid 32 that encloses a peeling/scrubbing chamber 34 that is configured to receive one or more produce items, such as fruits and vegetables, therein for peeling or scrubbing the various produce items. In the figures, housing 12 is configured with a generally square or rectangular cross-section having four side walls 28. Various cross-sectional configurations, such as circular, oval, hexagon and others, having different numbers of side walls 28 are also possible for apparatus 10 without departing from the scope of the present invention. Bottom wall 30 can be configured to be generally planar, as shown, or configured to include one or more feet or other members (not shown) on which apparatus 10 sits. Lid 32 is configured to substantially enclose chamber 34 when apparatus 10 is stored or in use. In a preferred embodiment, lid 32 is hingedly attached to one of side walls 28 with one or more hinges 36, shown in FIGS. 1 and 3, to allow the user to raise lid 32 and place produce in chamber 34 and remove the peeled or scrubbed produce therefrom after operation of apparatus 10. In other alternative embodiments, lid 32 can be removably connected to side walls 28 such that it is removed from and then placed on side walls 28 when adding or removing produce from chamber 34. Apparatus 10 can include one or more latches, not shown, for securely closing lid 32 and appropriate sealing mechanisms, also not shown, to prevent water or other fluids from exiting housing 12 when in use. As set forth in more detail below, lid 32 can be adapted to cooperate with fluid spray system 14 to spray fluid inside chamber 34 during use of apparatus 10. As known to those skilled in the art, housing 12 can be made out of variety of materials, including metals, plastics, glass, composites and others. As stated above, it is preferred that the materials be selected for their aesthetic and generally lightweight characteristics. Because apparatus 10 will be used with water and/or other cleaning fluids, the materials selected for housing 12 should be generally corrosion resistant and easy to clean after use for its intended purpose.

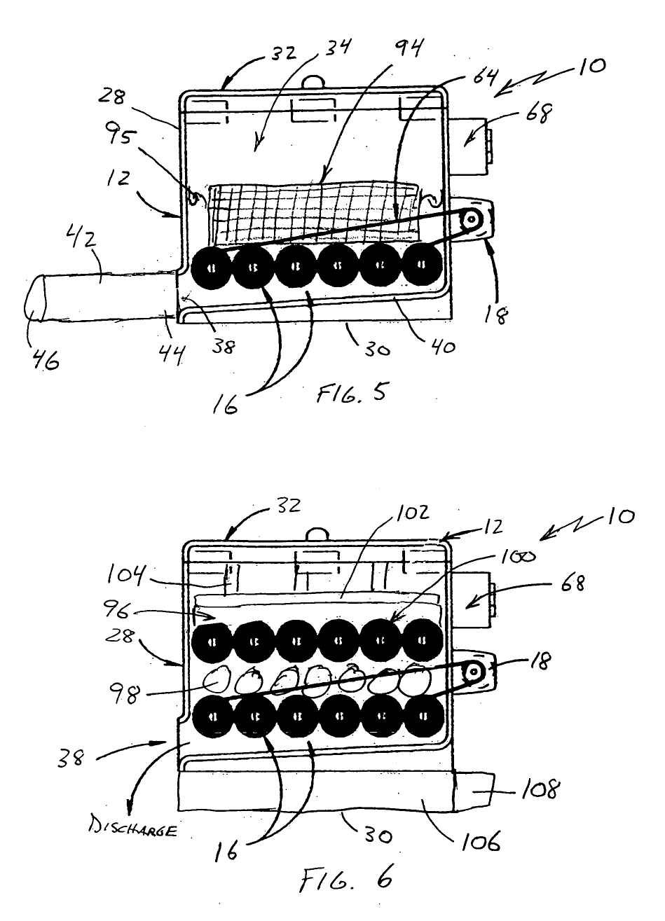

Housing 12 has a discharge opening 38, best shown in FIG. 2, on a side wall 28 configured to discharge the wash fluid, dirt/chemicals and removed portions of the produce from apparatus 10. Discharge opening 38 should be sized and configured to substantially allow the peeled portions of the produce and the wash fluid to be easily discharged from apparatus 10 without clogging opening 38. As shown, discharge opening 38 is preferably located at or near the bottom portion of side wall 28 to facilitate substantially emptying chamber 34 of fluid and peeled portions of produce. To further facilitate discharging the wash fluid and produce refuse from apparatus 10, an inclined base plate 40 can be positioned under rollers 16 to encourage the fluid and produce portions to flow to discharge opening 38 and out apparatus 10, as shown in FIG. 2. Alternatively, bottom wall 30 can be configured at an incline directed toward discharge opening 38. During use of the configuration shown in the figures, apparatus 10 should be placed substantially close to a suitable discharge receiver, such as sink 24, such that discharge wash fluid and produce refuse flows out discharge opening 38 into sink 24 or other receiver (i.e., a trash can or other container). Alternatively, apparatus 10 can be provided with a discharge hose 42, or like tubular member, shown in FIG. 5, having a first end 44 removably or fixedly attached to discharge opening 38 and an open second end 46 for discharging into an appropriate location, such as sink 24. Discharge hose 42 allows apparatus 10 to be placed on counter or table top 22 at a distance remote from sink 24 or other location to receive fluid and produce discharged from chamber 34. If desired, discharge hose 42 can be configured to retract into housing 12 or be removably attached to housing 12 so that it will be out of the way when apparatus 10 is stored or not in use. Discharge hose 42 can be made out of plastic, rubber or like materials that and be configured to be generally flexible or stiff, as desired.

One or more rollers 16 are rotatably disposed inside chamber 34 to peel or scrub produce placed therein. In the preferred embodiment, shown in the figures, apparatus 10 has a plurality of elongated abrasive rollers 16 that are configured to be removably attached to side walls 28. Although rollers 16 can be fixed inside housing 12, being removable allows the user to switch rollers 16 to be more or less abrasive depending on the user's desire to abrade (peel) or scrub the produce, the size and type of produce to be peeled or scrubbed inside chamber 34 and to replace any rollers 16 that have become worn or damaged due to use. As best shown in FIGS. 1 and 3, side walls 28 can be configured to facilitate easy installation and removal of rollers 16 by incorporating a bracket 48 for receiving one end of each of rollers 16 and an indent 50 for receiving the opposite end of rollers 16. Brackets 48, which can be utilized for both ends of rollers 16, need to allow rollers 16 to rotate inside chamber 34 in response to the operation of motor 18 and rotating mechanism 20, as explained in more detail below. Preferably, brackets 48 are fixedly attached to the inside of side wall 28 and are configured to allow the user to essentially “snap” rollers 16 therein to effectively secure rollers 16 in chamber 34. Various other configurations for rotatably positioning rollers 16 inside chamber 34 are also possible. For instance, brackets 48 can be located on the outside of housing 12. Rollers 16 should be sufficiently close together to prevent the produce from falling between adjacent rollers 16 and sufficiently spaced apart to allow the fluid and produce refuse, such as skin and the outer layer, to pass between adjacent rollers 16 to inclined plate 40 and out discharge opening 38.

To accomplish the peeling and scrubbing operations for apparatus 10, it is preferred that rollers 16 be configured to be abrasive and substantially extend across the width of chamber 34. As known in the art, including the prior art patents referenced herein, various abrasive mechanisms for rollers 16 are available. For instance, as shown in FIG. 4, rollers 16 can comprise an elongated, generally cylindrical base member 52 with a plurality of outwardly extending bristles 54 thereon that are configured to peel or scrub, as selected by the user, the skin or outer layer of the produce that is placed inside chamber 34. Base member 52 can be solid or hollow and be made in shapes other than cylindrical, such as square, rectangular, hexagonally shaped. Bristles 54 should be fixedly mounted to base member 52 and can be of various lengths and stiffness that are selected to obtain the desired peeling or scrubbing effect, which selection is also typically affected by the type and/or size of produce desired to be peeled or scrubbed. As also well known in the art, bristles 54 can be made out of various different materials, including plastic and metal, and be of various density spacing on base member 52. As an alternative to the use of bristles 54, rollers 16 can have the outer surface of base member 52 configured with varying degrees of roughness to more or less abrade or scrub the produce placed inside chamber 34. To obtain the desired abrasion or scrubbing effect, rollers 16 can be coated with abrasive materials, such as the various grit coatings known in the art. Rollers 16 can also utilize various outwardly extending substantially stiff pins or rods to provide the desired abrading effect. Because the distance between the ends of adjacent rollers 16 will generally be fixed, the gap between rollers can be controlled, thereby preventing produce from falling therethrough and allowing the fluid and produce refuse to pass, by the length and type of abrasive material utilized on rollers 16.

To rotatably drive rollers 16, apparatus 10 utilizes motor 18 and a cooperatively engaged rotating mechanism 20 to rotate rollers 16 inside chamber 34. In the preferred embodiment, shown in the figures, motor 18 is a relatively low power electric motor having a power cord 56 with a plug 58 that is configured to plug into the typical outlet found in homes, restaurants and other businesses. As known to those skilled in the art, however, motor 18 can be a hydraulic, pneumatic, battery-operated motor or other types of motors. In the preferred embodiment, motor 18 connects to rotating mechanism 20 to rotate the plurality of rollers 16. In one embodiment, rotating mechanism 20 is a belt-drive system with motor 18 having a first pulley 60 and each of rollers 16 have a corresponding second pulley 62 with belt 64 interconnecting first pulley 60 and each of second pulleys 62, as best shown in FIG. 2 (note that FIG. 1 and FIG. 3 shows system 14 without belt 14 to more clearly show pulley 60 and pulleys 62). The output shaft of motor 18 spins first pulley 60 which causes belt 64 to move and spin each of second pulleys 62 to rotate rollers 16. An axle member 66, shown in FIG. 1, interconnects each of second pulleys 62 with each of rollers 16. As known to those skilled in the art, various different configurations for rotating mechanism 20 are available. For instance, a chain-drive system or rod linkage system can be utilized instead of the belt-drive system shown in the figures. Instead of a plurality of second pulleys 62, such as one for each roller 16 as shown in FIG. 2, a single second pulley 62 can be configured to cooperate with each roller 16 disposed inside chamber 34.

The preferred embodiment of the peeling and scrubbing apparatus 10 of the present invention also includes a controller mechanism 68 disposed between power cord 56 and motor 18 that is configured to operatively control motor 18 and/or fluid spray system 14. In the embodiment shown in the figures, controller mechanism 68 comprises controller housing 70, one or more switches 72 and power line 74. Controller housing 70 should be configured to enclose the operative electrical and/or electro-mechanical mechanisms and protect against the intrusion of water and other fluids. The one or more switches 72 can include the typical on/off switch(es) and switches for controlling the speed of motor 18 (i.e., high, medium or low speed), the on/off operation of spray system 14, the quantity and/or pressure of the spray or the introduction of cleaning chemicals into spray system 14. In one configuration, the user operates apparatus 10 by manually controlling the on/off switch on controller mechanism 68. In another configuration, controller mechanism 68 includes a timer or like device to allow the user to set an amount of time to peel and clean with an automatic turn-off time. If desired, controller mechanism 68 can be computer controlled by including the appropriate computer controller cards or chips and apparatus 10 can include various automated processes. For instance, controller mechanism 68 can include a pressure-sensitive element or elements that automatically starts motor 18 to rotate rollers 16 when weight is placed on rollers 16 and lid 32 is closed. Controller mechanism 68 can be configured to allow the user to set the type, size and/or quantity of produce to be peeled and/or cleaned inside chamber 34.

The preferred embodiment of apparatus 10 includes fluid spray system 14 to wash dirt, chemicals and other materials off of the produce and to wash away (i.e., out discharge opening 38) the skin or outer layer of the produce. In a preferred configuration, shown in FIG. 3, fluid spray mechanism 14 includes one or more spray nozzles 76 inside chamber 34 to spray on the produce as it is being abraded or scrubbed by rollers 16. The one or more spray nozzles 76 should be connected to the first end 78 of fluid line or hose 80 that is configured with a coupler 82 at the second end 84 thereof. Coupler 82 should be configured to removably connect to a source of fluid 26, such as the faucet shown in FIG. 1. In this preferred configuration, faucet 26 would supply pressurized fluid to spray nozzles 76. The preferred embodiment of apparatus 10 of the present invention also includes a cleaning fluid container 86, such as the bottle shown in FIG. 3, disposed in fluid line 80. In this configuration, water would flow from faucet 26 into fluid container 86, mix with the cleaning solution 88 contained therein, and then flow to spray nozzle 76 where it is sprayed inside chamber 34 onto the produce being peeled by rollers 16. Various cleaning solutions 88, including soap or other solvents, can be placed inside fluid container 86. The operation of fluid spray system 14 can be controlled by operating the source of water 26, such as by controlling the flow of water out of the kitchen sink faucet. Alternatively, as set forth above, controller mechanism 68 can be adapted to operatively control fluid spray system 14 in addition to the operation of rollers 16.

In an alternative embodiment of apparatus 10, shown in the figures, spray nozzles 76 are incorporated in or attached to lid 32 and configured to spray into chamber 34 from above. Other locations, such along side walls 28 are also possible for spray nozzles 76. In the configuration shown in FIG. 3, first end 78 of fluid line 80 is incorporated within cavity 90 of lid 32 to exit at hole 92, preferably supported by a grommet or other device. As with power cord 56, fluid spray mechanism 14 could include a mechanism to allow fluid line 80 to be rolled or retracted into lid 32 for storage or other non-use of apparatus 10.

In a preferred embodiment of apparatus 10 of the present invention, shown in FIG. 5, apparatus 10 is also adapted to removably receive a basket 94 configured to hold smaller sized produce, such as berries and cherry tomatoes, therein to prevent loss of the smaller produce between rollers 16. Preferably, at least the bottom portion of basket 94 would be a mesh configuration, or the like, to allow bristles 54 to pass through basket 94 and scrub the produce placed inside basket 92. Although basket 94 can be configured to merely rest on top of rollers 16, it is preferred that housing 12 include one or more clips 95 inside chamber 34 that are configured to interact with basket 94 to hold basket 94 in place immediately on top of rollers 16. In this manner, berries, cherry tomatoes and other small produce can be scrubbed inside chamber 34 without substantial loss of the produce out discharge opening 38.

In another configuration of the peeling and scrubbing apparatus 10 of the present invention, shown in FIG. 6, apparatus 10 also includes an upper component 96 configured to rest on top of the produce, shown as 98. In one configuration, upper component 96 does not have any abrasive rollers or other devices, instead it can be a generally planar member, In the preferred embodiment, however, upper component 96 includes one or more upper rollers 100 rotatably attached to roller frame 102. Although upper rollers 100 are configured to abrade or scrub produce 98 like rollers 16, upper rollers 100 can be configured with the same or different type of abrading mechanism. In the preferred embodiment, upper component 96 is not motor-driven, instead upper rollers 100 are configured to freely rotate by the rolling action of produce 98 caused by the rotation of rollers 16. Also in the preferred embodiment, one or more springs members 104 can apply a slight downward force to upper component 96 to effectively squeeze produce 98 between the two sets of rollers 16 and 100. In this configuration upper component 96 can be configured to be attached to lid 32, as shown in FIG. 6, or to side walls 28 and configured to swing down from above onto produce 98 placed on top of rollers 16. In an alternative embodiment, not shown, upper component 96 is configured to merely “float” on top of produce 98, with the weight of upper component 96 providing the desired downward force to contain produce 98. In either configuration, the use of upper roller component 96 will prevent produce 98 from bouncing on top of rollers 16, which could reduce the peeling or scrubbing effectiveness of rollers 16 for some types of produce. Generally, apparatus 10 should be configured such that upper component 96 is not used when basket 92 is being used to scrub smaller sized produce.

In use, the user of apparatus 10 places apparatus 10 on a counter or table top 22 near a source of fluid 26 and a source of power (i.e., an electrical outlet) adaptable for receiving plug 58 on the end of power cord 56. The user opens chamber 34 inside housing 12 by removing or swinging open, if attached with hinges 36, lid 32. If necessary, the user removes rollers 16 and replaces them with rollers 16 configured to beneficially peel or scrub the produce 98 desired to be peeled and scrubbed by apparatus 10. If desired, cleaning solution 88 can be placed inside fluid container 86. Coupler 82 is connected to the source of fluid (i.e., the faucet) and plug 58 is connected to an electrical outlet. With the appropriate rollers 16 and any cleaning solution 88 in place, the user positions produce 98 inside chamber 34 on top of rollers 16, closes lid 32, turns on the fluid supply to deliver water to spray nozzles 76 and then starts motor 18. Motor 18 drives rotating mechanism 14 to cause rollers 16 to rotate inside chamber 34. Bristles 54, or other abrading members of rollers 16, peel or scrub the skin or outer layer of produce 98. Fluid from spray nozzles 76 washes away any dirt, chemicals or other materials on produce 98 and the removed skin or outer layer of produce 98. This refuse passes between the rollers and moves out discharge opening 38 to be deposited into sink 24 or another appropriate container. After the desired length of time for operating rollers 16 has passed, which can be set by a timer that is part of controller mechanism 68, motor 18 turns off and fluid stops flowing through fluid line 80. The user lifts lid 32 to remove the peeled or scrubbed produce 98 from inside chamber 34. If desired or necessary, additional fluid can be sprayed inside chamber 34 to further wash away any refuse from inside of chamber 34. For smaller produce, the user can place the small produce inside basket 92 to prevent undesirable waste of the produce 98 that would otherwise result from being damaged by rollers 16. If the produce 98 in chamber 34 tends to bounce undesirably, the user can use upper component 96 to hold produce 98 on top of rollers 16.

In an alternative configuration of apparatus 10, also shown in FIG. 6, apparatus 10 includes fluid reservoir 106 at the bottom of housing 12 that is configured to store a quantity of fluid for the source of fluid 26 for use in cleaning produce inside chamber 34. In this configuration, it would not be necessary to place apparatus 10 near an outside source of fluid 26, such as the faucet shown in FIG. 1 and it would not be necessary to utilize an external fluid line 80 and coupler 82. Fluid reservoir 106 can contain water, cleaning fluids or a mixture of water and cleaning fluids. To supply the fluid under pressure to spray nozzles 76, a pump 108 can be operatively connected to motor 18 and fluid line 80.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

1. An apparatus for peeling and scrubbing produce, comprising:
a housing forming a substantially closeable chamber, said housing comprising one or more side walls, a bottom wall and a lid, said housing having a discharge opening;
a spray system configured to spray a fluid in said chamber, said spray system having one or more spray nozzles connected to a fluid line, said fluid line adapted for connection to a source of fluid, at least a portion of said one or more spray nozzles operatively disposed inside said chamber;
one or more rollers rotatably disposed inside said chamber;
means for rotating said one or more rollers, said rotating means operatively connected to each of said one or more rollers; and
a motor operatively connected to said rotating means and configured to drive said rotating means and rotate each of said one or more rollers.

2. The apparatus according to claim 1, wherein said housing is sized and configured to use the apparatus on a counter or table top.

3. The apparatus according to claim 1, wherein said fluid line has a coupler to removably connect to said source of fluid.

4. The apparatus according to claim 1 further comprising a fluid container adapted to be removably connected to said fluid line, said fluid container suitable for storing a cleaning solution and delivering said cleaning solution to said chamber.

5. The apparatus according to claim 1, wherein said one or more spray nozzles are attached to or incorporated in said lid and at least a portion of said fluid line is disposed inside said lid.

6. The apparatus according to claim 1, wherein each of said one or more rollers are configured to be abrasive.

7. The apparatus according to claim 6, wherein each of said one or more rollers comprises a base member having a plurality of outwardly extending bristles.

8. The apparatus according to claim 1, wherein said one or more rollers are removably disposed inside said chamber to allow changing of said one or more rollers to selectively peel or scrub produce.

9. The apparatus according to claim 8 further comprising a bracket attached to at least one end of each of said one or more rollers, said bracket configured to securely receive said end of said rollers.

10. The apparatus according to claim 1, wherein said motor is an electric motor.

11. The apparatus according to claim 1 further comprising a basket for holding one or more small sized produce, wherein said chamber is configured to receive said basket and abrade said one or more small sized produce.

12. The apparatus according to claim 1 further comprising an upper component having one or more upper rollers rotatably attached to a roller frame, said upper component configured to be received in said chamber and confine the produce between said one or more rollers and said one or more upper rollers.

13. The apparatus according to claim 1 further comprising a reservoir configured to store said source of fluid and a pump configured to pump said fluid through said fluid line to said one or more spray nozzles.

14. The apparatus according to claim 1 further comprising a controller in electrical communication with said motor, said controller configured to allow a user of said apparatus to operatively control said motor and the rotation of said one or more rollers.

15. An apparatus for peeling and scrubbing produce, comprising:
a housing forming a substantially closeable chamber, said housing comprising one or more side walls, a bottom wall and a lid, said housing having a discharge opening, said housing sized and configured to use the apparatus on a counter or table top;
a spray system configured to spray a fluid in said chamber, said spray system having one or more spray nozzles connected to a fluid line, said fluid line having a coupler adapted for removable connection to a source of fluid, at least a portion of said one or more spray nozzles operatively disposed inside said chamber;
a fluid container disposed in said fluid line, said fluid container suitable for storing a cleaning solution and delivering said cleaning solution to said chamber;
one or more abrasive rollers rotatably disposed inside said chamber;
means for rotating said one or more abrasive rollers, said rotating means operatively connected to each of said one or more abrasive rollers; and
a motor operatively connected to said rotating means and configured to drive said rotating means and rotate each of said one or more abrasive rollers.

16. The apparatus according to claim 15, wherein each of said one or more abrasive rollers comprises a base member having a plurality of outwardly extending bristles.

17. The apparatus according to claim 15 further comprising a bracket attached to at least one end of each of said one or more abrasive rollers, said bracket configured to securely receive said end of said abrasive rollers.

18. The apparatus according to claim 15, wherein one or more rollers are removably disposed inside said chamber to allow changing of said one or more rollers to selectively peel or scrub produce.

19. An apparatus for peeling and scrubbing produce, comprising:
a housing forming a substantially closeable chamber, said housing comprising one or more side walls, a bottom wall and a lid, said housing having a discharge opening, said housing sized and configured for use on a counter or table top;
a spray system configured to spray a fluid in said chamber, said spray system having one or more spray nozzles connected to a fluid line, said fluid line having a coupler adapted for removable connection to a source of fluid, at least a portion of said one or more spray nozzles operatively disposed inside said chamber;
a fluid container disposed in said fluid line, said fluid container suitable for storing a cleaning solution and delivering said cleaning solution to said chamber;
one or more abrasive rollers rotatably disposed inside said chamber;
one or more brackets attached to said housing, each of said one or more brackets adapted to removably receive an end of one of said one or more abrasive rollers and secure said abrasive roller in said chamber;
means for rotating each of said one or more abrasive rollers, said rotating means operatively connected to each of said one or more abrasive rollers;
a motor operatively connected to said rotating means and configured to drive said rotating means and rotate each of said one or more abrasive rollers; and
a controller in electrical communication with said motor, said controller configured to allow a user of said apparatus to operatively control said motor and the rotation of said one or more abrasive rollers.

20. The apparatus according to claim 19, wherein said controller is further configured to operatively control said spray system.
